(19) United States
(12) Patent Application Publication
(10) Pub. No.: US 2017/0247289 A1
(43) Pub. Date: Aug. 31, 2017

(54) COATED GLASS OR GLASS CERAMIC ARTICLE

(71) Applicant: SCHOTT AG, Mainz (DE)

(72) Inventors: Holger Waldschmidt, Nieder-Wiessen (DE); Fabian Wagner, Mainz (DE); Martin Spier, Mainz (DE)

(73) Assignee: SCHOTT AG, Mainz (DE)

(21) Appl. No.: 15/445,167

(22) Filed: Feb. 28, 2017

(30) Foreign Application Priority Data
Feb. 29, 2016 (DE) 102016103524.6
Aug. 31, 2016 (DE) 102016116262.0

(51) Int. Cl. C03C 17/25; C03C 4/02; F21V 3/00; H05B 3/74; F21V 8/00; C03C 1/04; C03C 10/00

(52) U.S. Cl. CPC C03C 17/25; C03C 1/04; C03C 4/02; C03C 10/00; H05B 3/74; G02B 6/001; F21V 3/00; C03C 2218/113; C03C 2218/328; C03C 2217/485; C03C 2204/04; F21Y 2115/10

(57) ABSTRACT

A method is provided for producing a glass or glass ceramic article that includes: providing a sheet-like glass or glass ceramic substrate having two opposite faces, which in the visible spectral range from 380 nm to 780 nm exhibits light transmittance of at least 1% for visible light that passes from one face to the opposite face; providing an opaque coating on one face where the coating exhibits light transmittance of not more than 5% in the visible spectral range from 380 nm to 780 nm; and directing a pulsed laser beam onto the opaque coating and locally removing the coating by ablation down to the surface of the glass or glass ceramic article, repeatedly at different locations, thereby producing a pattern of a multitude of openings defining a perforated area in the opaque coating, so that the opaque coating becomes semi-transparent in the area.

### CROSS REFERENCE TO RELATED APPLICATIONS

This application claims benefit under 35 U.S.C. §119(a) of German Application No. 102016103524.6 filed Feb. 29, 2016 and German Application No. 102016116262.0 filed Aug. 31, 2016, the entire contents of both of which are incorporated herein by reference.

### BACKGROUND

1. Field of the Invention

The invention generally relates to glass or glass ceramic articles which are provided with an opaque coating. More particularly, the invention relates to such articles which are provided with luminous display elements or are intended to be equipped with luminous display elements.

2. Related Art

From prior art, glass ceramic cooktops are known which are coated on their lower surface in order to modify the appearance and also in order to conceal parts of the cooktop installed below the glass ceramic.

One option for this purpose are sol-gel coatings which are quite heat resistant and are distinguished by good adhesion to the glass ceramic plate. In order to conceal interior parts of a cooktop, opaque coatings are typically used.

For some applications it is desirable that the coating does not cover the entire surface but has windows. Such windows are in particular arranged in front of luminous display elements, so that these display elements shine through the glass ceramic plate to be visible to an operator which looks at the utilization side of the cooktop. Partly, these windows are covered by translucent coatings to improve aesthetic appearance. With the same hue, a homogeneous surface is created in this manner.

Nowadays, screen printing is employed for printing icons, characters, or other logos and designs on cooktops. However, it is difficult in this manner to produce very fine patterns such as thin lines, for example.

Moreover, in case of screen printing reproducibility is difficult in areas of very fine resolution or runouts of lines due to the screen printing mesh. Furthermore, for every new product request or design change a new screen needs to be created, so that set-up costs are very high, which is especially noticeable in small series. Manufacturing of individual designs for each end user is therefore expensive.

Furthermore, in case of multilayer coatings, a problem that arises with a printing technique such as screen printing is that congruent patterning is difficult. Therefore, in case of multilayer coatings usually a larger window is left exposed in the coating, to allow to pattern a further coating layer with exactly the desired pattern in the area of the window. However, especially in combination with light-emitting display elements the window might be visible if the more precisely patterned coating layer is not completely opaque.

EP 0 868 960 B1 proposes a method for manufacturing control panels, in particular for electrical household appliances, wherein at least one personalized laser engraving is produced in at least one screen printed layer which was previously applied to a basic panel blank made of glass, the engraving consisting in material removal so as to form decorative features, icons, or similar signs in the screen printed layer, and then these engravings are covered by manually or automatically applying a layer of a different color, which may be effected immediately after the engraving step or in a separate processing step.

As described in Applicant's German patent application DE 10 2015 102 743.7, it is possible to create light applications in cooktop panels with very thin exposed lines or dots (<40 μm), which exhibit a so-called dead front effect, which is to say that they are not visible with the eye when the light source is not illuminated. Such fine patterns can be produced particularly easily by laser ablation of ink layers on transparent glass substrates. At the same time, however, requirements on the accuracy of positioning light-emitting elements are high, due to the fine patterns. In particular in the case of multiple features, i.e. multiple very closely spaced light applications in a single panel, unattractive light crosstalk or non-illuminated areas may result.

For this purpose, special inks, so-called translucent inks, were developed for conventional screen printing. Such inks can be used to re-print rather large continuous exposed areas in an ink layer within which light elements can then be arranged more easily. The translucent inks prevent a look below the glass panel, but transmit the light of the light-emitting elements. However, generation and processing thereof is expensive, and due to their modified composition they produce a different color appearance when looking from above than the opaque basic color that was printed first.

### SUMMARY

Therefore, an object of the invention is to provide a method for producing a glass or glass ceramic article which has the desired visual properties but can be produced at lower costs in comparison to the use of the screen printing process.

Accordingly, the invention provides a method for producing a glass or glass ceramic article, comprising the steps of: providing a sheet-like glass or glass ceramic substrate having two opposite faces, which in the visible spectral range from 380 nm to 780 nm exhibits light transmittance τᵥᵢₛ of at least 1%, preferably at least 30% for visible light that passes across the glass or glass ceramic substrate from one face to the opposite face; providing an opaque coating on one face of the glass or glass ceramic substrate, which coating exhibits light transmittance τᵥᵢₛ of not more than 5% in the visible spectral range from 380 nm to 788 nm; and directing a pulsed laser beam onto the opaque coating and locally removing the coating by ablation down to the surface of the glass or glass ceramic article, repeatedly at different locations, thereby producing a pattern of a multitude of openings defining a perforated area in the opaque coating, so that the opaque coating becomes semi-transparent in this core area of the pattern. According to the invention, the pattern is preferably composed of openings or dots that are arranged at a spacing or dot spacing to each other and have a size.

The spacing of the openings from each other is less than 200 μm, preferably less than 150 μm, more preferably less than 100 μm.

The openings have a size of less than 30 μm, preferably less than 20 μm.

If spacing and dot size are selected as described, the perforated area, that is to say the core area has the appearance of a translucent ink and allows for greater positioning tolerances for light-emitting elements. In case of icons exposed using a laser, such areas offer some advantages. In fact, the color of the icons is not defined by the ablated area but by the light-emitting element itself. In this way it is possible to address a plurality of products by different symbols with a single glass panel, if necessary.

A further process parameter for the method according to the invention is the percentage of the ablated surface area in relation to the total surface area. This percentage is described by a ratio of ablated surface area to non-processed surface area within a perforated semi-transparent area, i.e. the core area. The inventors have found that areas with an ablated percentage surface area of more than 0.5% of the total surface area create a different color appearance. In the case of dot-shaped openings, the ratio of ablated surface area to non-processed surface area is determined according to the formula ( [symbol] r²·100%)/(a²), wherein r is the radius of a dot and a is the spacing between two dots. In the case of openings having a different shape, the percentage of the ablated surface area in relation to the total surface area is determined by the ratio of the summed surface areas of the openings to the surface area of the non-processed surface within the perforated semi-transparent area. Such areas will appear lighter or darker to the viewer, depending on the underlying color system. However, areas with an ablated percentage surface area of less than 1%, in particular less than 0.5% of the total surface area are rather uninteresting, since light applications will appear slightly pixelated. Therefore, in order to obtain an area with the highest possible resolution, surface with an ablated percentage surface area of more than 0.8%, preferably more than 1%, most preferably more than 1.5% have to be selected.

In order to mitigate or eliminate the different color appearance, a transition area was created in which the ablated percentage surface area is reduced from the perforated core area to the non-ablated area with less than 2% per mm, preferably less than 1% per mm, more preferably less than 0.5% per mm.

In this case, the reduction may be accomplished so that the ablated percentage surface area is preferably reduced to less than 0.5% of the total surface area at the side of the transition region adjoining the non-ablated area.

The value of the gradient of the percentage surface area in the transition area may either be constant in the entire transition area or may vary. In case of a varying gradient, the aforementioned limit values refer to a mean value averaged along the gradient over the entire width of the transition area.

Therefore, the scope of the invention furthermore includes a method in which a transition area is created along the periphery of the perforated area, i.e. along the periphery of the core area, in which further dots are ablated so that the percentage surface area, determined by the ratio of ablated surface area to non-processed surface area is lower on average within the transition area than within the core area.

The percentage of the total ablated surface area comprising the core area and the transition area may be less than 0.5% of the total surface area.

Such percentage surface areas can be achieved with smaller openings or with larger spacings of the openings.

If, however, the glass or glass ceramic substrate is provided with a very light or very dark decorative layer, the described measure might not be sufficient, since under these conditions a sufficient dead front effect is possibly not created. For example, lines having a width of 20 μm may clearly be visible especially against a light decorative layer.

The inventors have found that the dead front effect can be improved by a technique known as dithering which is used, for example in computer graphics, to create the illusion of a greater color depth, for example when images have to be reproduced with reduced color depth due to technical limitations. In this case, the lacking colors are approximated by a specific arrangement of the pixels from available colors. In this way, hard color transitions are avoided, since the human eye perceives the dithering as a mixture of individual colors.

According to the invention, the size and position of the openings are selected so that in a backlit state a continuous preferably exposed pattern is perceived, while a sufficient dead front effect is established in the off state, which will described in more detail below.

For this purpose, the cutout is subdivided into a multitude of smaller areas, which can be selectively arranged as needed so as to occupy more or less percentage surface area of the actual distribution.

Preferably, a stochastic or irregular distribution of the openings is selected for this purpose. Alternatively or additionally, the size of the preferably dot-shaped openings may preferably be varied stochastically as well. Due to the stochastic arrangement and/or size of the individual openings, the perceptibility in the off state is reduced and at the same time the desired shape is preserved in the backlit state. This in particular enhances the display capability of a cooktop panel made from the glass or glass ceramic panel, since moire patterns of regularly arranged picture elements (pixels) of a display can be reduced or even avoided due to the stochastic or irregular arrangement.

Applicant's German patent application DE 10 2015 102 743 mentions that the perceived feature width of fine openings (<80 μm) strongly depends on the luminous intensity of the light source arranged underneath. Generally, greater luminous intensity will cause an increase in the perceived feature width.

When luminous intensity is altered, linear features will appear to have different widths. By means of adaptive lighting systems it is therefore possible to display different degrees with one and the same opening in the backlit state without need to modify the actual feature width, which could otherwise adversely affect the dead front effect.

This finding can be exploited for dithering. The distribution and degree of random, i.e. stochastic or irregular offset and the size of the openings in the subdivided cutout are chosen so that in combination with the luminous intensity, a continuous homogeneous feature is resulting in the backlit state and a satisfactory dead front effect in the off state. The greater the luminous intensity, the smaller the actual percentage of cutouts can be. The latter favors the dead front effect as desired.

Therefore, a method is furthermore within the scope of the invention for producing a glass or glass ceramic article in which the spacings between the openings or dots vary, in particular if these spacings vary according to a random distribution and therefore stochastically. Also within the scope of the invention is a method for producing a glass or glass ceramic article in which the sizes of the openings or dots vary, in particular if these sizes of the openings or dots vary according to a random distribution and therefore stochastically.

The step of perforating may be followed by a cleaning step. This cleaning step may in particular be performed using an adhesive roller.

The step of cleaning may be followed by a method step in which the perforated area is provided with a sealing layer, preferably a transparent sealing layer. In a particular embodiment, the transparent sealing layer may be dyed, preferably by colorants and/or pigments.

The material of the glass or glass ceramic substrate may be selected so that in the infrared spectral range, in particular at a wavelength of 1064 nm, and also at 532 nm, the material of the glass or glass ceramic article has an ablation threshold that is higher than the ablation threshold of the opaque coating.

Furthermore, it is advantageous if the opaque coating is selected so that it comprises a matrix of an oxidic network with decorative pigments embedded therein. It is furthermore advantageous if the matrix is produced from a sol-gel material which is inorganically/organically crosslinked, once cured.

Furthermore within the scope of the invention is a glass or glass ceramic article produced by the method of the invention. Such a glass or glass ceramic article comprises a glass or glass ceramic substrate having two opposite faces, wherein one face of the glass or glass ceramic substrate is provided with an opaque coating which exhibits a light transmittance τᵥᵢₛ of not more than 5% in the visible spectral range from 380 nm to 780 nm, and wherein the opaque coating includes an area that is provided with a pattern of openings which allow light that is incident onto the surface of the coating to pass through the coating and through the glass or glass ceramic substrate so that this core area appears semi-transparent, wherein the openings or dots are spaced by less than 200 μm, preferably less than 150 μm, more preferably less than 100 μm, and wherein furthermore a transition area is provided along a periphery of the perforated core area, which includes further ablated openings in a manner so that the ablated percentage surface area defined by a ratio of ablated surface area to non-processed surface area is lower on average within the transition area than within the core area.

According to the invention, such a glass or glass ceramic article may form the control surface of a household appliance. In this case, at least one light-emitting element is arranged in an interior of the household appliance, so that light emitted from this light-emitting element is incident onto the openings in the opaque coating and is able to pass through the openings and the substrate.

In such a household appliance, the opaque coating can be applied on a face of the glass or glass ceramic article, which faces the interior.

The household appliance of the invention comprises at least one light-emitting diode or laser diode as the light-emitting element.

A household appliance of this type may furthermore comprise a diffusing element or a side-emitting light guide for distributing the light emitted by the light-emitting element throughout the perforated area.

A further possible application for a glass or glass ceramic article according to the invention is to use it as a component of interior linings of automobiles, and such a component likewise comprises at least one light-emitting diode or laser diode. The opaque coating faces the interior of the vehicle.

### BRIEF DESCRIPTION OF THE DRAWINGS

The invention will now be described in more detail with reference to the accompanying figures. In the figures, the same reference numerals designate the same or equivalent elements. In the drawings:

FIG. 1 shows a coated glass or glass ceramic article;

FIG. 2 shows an apparatus for laser ablation for producing a glass or glass ceramic article according to the invention;

FIG. 3 shows a glass or glass ceramic article produced by the method;

FIG. 4 shows a glass ceramic cooktop comprising a glass ceramic article according to the invention as a cooktop panel;

FIG. 5 shows an embodiment with a side-emitting light guide for illuminating the dot pattern;

FIG. 6 shows a refinement of the embodiment illustrated in FIG. 3;

FIGS. 7a to 7b schematically illustrate a variation of the dot spacings;

FIGS. 8a to 8f schematically illustrate stochastic distributions of dot spacings and dot sizes for different ratios of ablated surface area to total surface area;

FIG. 9a illustrates a portion of a pattern of dot-shaped openings comprising a perforated core area and a perforated transition area; and

FIG. 9b illustrates a portion of another pattern of dot-shaped openings comprising a perforated core area and a perforated transition area.

### DETAILED DESCRIPTION

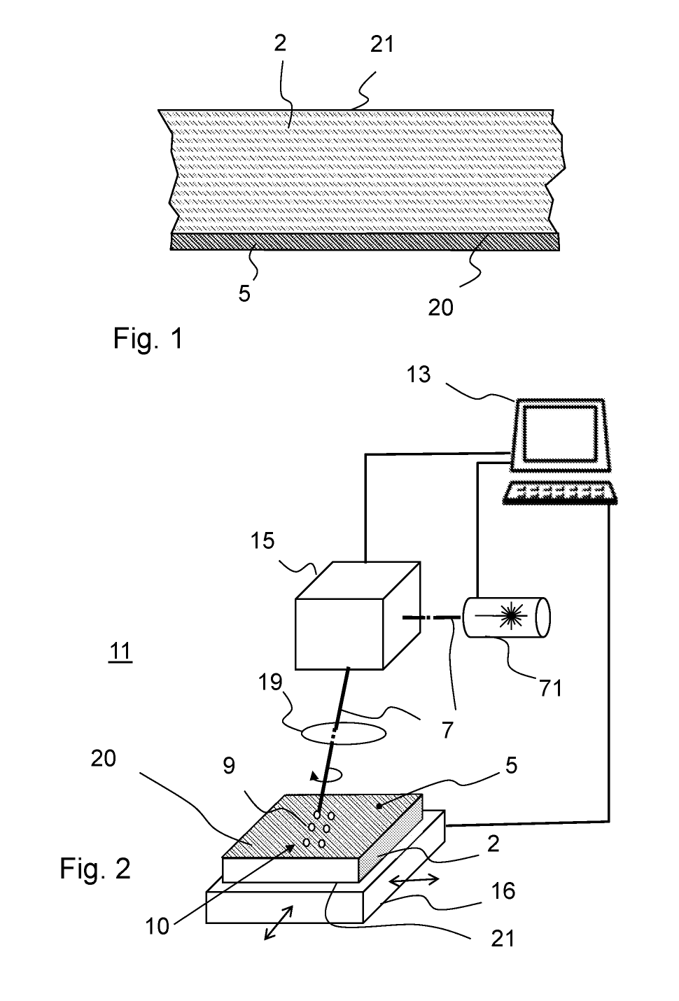

For producing a glass or glass ceramic article according to the invention, initially a planar or sheet-like glass or glass ceramic substrate 2 is provided. Accordingly, the glass or glass ceramic substrate 2 has two opposite faces 20, 21. One of the faces is provided with an opaque or lightproof layer 5, in the example shown in FIG. 1 this is face 20.

Particularly preferred coatings 5 include inorganic and/or inorganically-organically modified sol-gel coatings. The oxidic network may preferably consist of SiO₂, TiO₂, ZrO₂, Al₂O₃ components. The network may moreover include organic residues.

Pigments that may be added in particular include color-imparting pigments in the form of metal oxides, in particular cobalt oxides/spinels, cobalt-aluminum spinels, cobalt-aluminum-zinc oxides, cobalt-aluminum-silicon oxides, cobalt-titanium spinels, cobalt-chromium spinels, cobalt-aluminum-chromium oxides, cobalt-nickel-manganese-iron-chromium oxides/spinels, cobalt-nickel-zinc-titanium-aluminum oxides/spinels, chromium-iron-nickel-manganese oxides/spinels, cobalt-iron-chromium oxides/spinels, nickel-iron-chromium oxides/spinels, iron-manganese oxide/spinels, iron oxides, iron-chromium oxides, iron-chromium-tin-titanium oxide, copper-chromium spinels, nickel-chromium-antimony-titanium oxides, titanium oxides, zirconium-silicon-iron oxides/spinels.

Preferred pigments are absorption pigments, platelet- or rod-shaped pigments, coated effect pigments e.g. based on mica. Also suitable are pigments such as carbon blacks, graphite, and dyes.

Also, the layers (decorative/sealing layers) may include further constituents such as fillers, preferably nanoscale fillers. Suitable fillers are in particular, SiOₓ particles, aluminum oxide particles, fumed silica, lime-soda particles, alkali aluminosilicate particles, polysiloxane spheres, borosilicate glass spheres, and/or hollow glass spheres.

Such coatings are highly durable and temperature resistant and can be produced in an almost unlimited variety of visual appearances, depending on the choice of the decorative pigments. However, the patterning of such coatings is a problem, especially if they contain a high proportion of pigments, or if the individual pigment particles are rather large. The latter is for instance the case when platelet-shaped decorative pigments are used to produce metallic or glitter effects. The inventive method even permits to sever the individual pigment particles and to cut them exactly when the openings or holes are created.

The decorative pigments and their content in the coating composition are selected so that with the intended layer thickness of the coating 5 the latter has a transmittance in the visible spectral range of less than 5%. Optionally, such a low transmittance may as well be achieved by a multi-layered coating.

Suitable coating compositions and coatings prepared therefrom are known, inter alia, from DE 10 2008 031 426 A1, and from DE 10 2008 031 428 A1, and the contents disclosed therein concerning such coating compositions and coatings is hereby fully incorporated into the subject matter of the present application. Accordingly, in one embodiment of the invention an opaque coating 5 can be produced by preparing the decorative layer by a sol-gel process in a first step, the layer being applied on the glass or glass ceramic substrate and cured by baking, and in a second step the decorative layer is covered by a sealing layer which is also produced by a sol-gel process, in which inorganic decorative pigments and fillers are mixed with a sol, wherein the inorganic decorative pigments comprise platelet-shaped pigment particles and inorganic solid lubricant particles which are added in a ratio ranging from 10:1 to 1:1 wt %, preferably from 5:1 to 1:1 wt %, and more preferably from 3:1 to 1.5:1 wt %, and wherein the prepared mixture is applied to the glass ceramic substrate provided with the cured decorative layer and is then cured at elevated temperatures. The cured sealing layer may have the same composition as the cured decorative layer, with the difference that in terms of the number of organic residues the metal oxide network of the sealing layer has more organic residues than the metal oxide network of the decorative layer, preferably at least 5% more organic residues. Metal oxide network herein also refers to an oxidic network including elements which are semiconducting in elemental form (i.e. in particular the SiO₂ network already mentioned, inter alia).

Unlike described before, other sealing layers may likewise be used. In addition to the sol-gel sealing layers described above, silicone layers or silicone-based layers are for instance suitable as well to seal an underlying coating. Sealing layers based on organic polymers such as polyurethanes, polyacrylates etc. are also possible. The sealing layers may be pigmented.

The sealing layers may be transparent, dyed transparent, translucent, or opaque. Pigmented sealing layers are preferred.

Ceramic inks that are specifically adapted to the requirements of a ceramic lower surface coating may as well be used on the face. A preferred embodiment of this invention are hybrid layers such as described in DE 10 2012 103 507 A1.

Once the coating 5 has been produced, an apparatus for laser ablation is then used to create a multitude of openings or holes 9, which together define a perforated area 10. An example of such an apparatus 11 is shown in FIG. 2.

The apparatus for laser ablation 11 comprises a laser 71 and a device for guiding the laser beam 7 produced by the laser 71 over the surface 20 of the glass or glass ceramic substrate 2 coated with a coating 5. For example a galvanometer scanner 15 can be employed as the device for guiding the laser beam 7 over the surface.

For some applications it is desired, in addition to perforation, to produce cutouts having the shape of long straight lines, for example in cooktop panels where such lines are intended to delineate a cooking area or to mark a cooking zone. For long straight lines it is advantageous to use a polygon scanner, because when stitching long lines a small offset might quickly be produced. Due to the offset the line would become wider at the crossing point and therefore would appear much brighter at this point when backlit.

As illustrated in FIG. 2, means for displacing the glass ceramic element 1 may be provided alternatively or in addition to a galvanometer scanner. Particularly suitable for this purpose is an X-Y table 16, also referred to as a cross table. In such an embodiment, the laser beam 7 can be hold stationary and the openings 9 with the desired shape can be introduced into the coating 5 by moving the X-Y table with the glass or glass ceramic substrate 2 placed thereon.

The openings or holes preferably have the shape of circular dots. However, the openings may as well have the shape of elongated ovals. Other geometries are also conceivable, e.g. parallel lines.

In the case of dot-shaped openings, these dots form a dot pattern as a whole. The spacing between the individual openings or dots should be less than 200 μm, preferably less than 150 μm, more preferably less than 100 μm. The openings or dots have a size of less than 30 μm, preferably less than 20 μm.

In order to ensure consistent high accuracies, it is also possible to use a synchronized scanning and displacing apparatus. In this case, the movement of table 16 or another means for displacing the substrate 2 is synchronized with the deflection of the scanner, e.g. galvanometer scanner 15.

For focusing the laser beam 7 on the surface in order to achieve the highest possible intensity, appropriate focusing optics 19 may be provided. In the example shown in FIG. 2, this focusing optics are arranged downstream of galvanometer scanner 15. However, it will be apparent to those skilled in the art that other configurations suitable to focus the laser beam 7 onto the glass ceramic element 1 are likewise possible. In order to achieve short focal lengths it is favorable to arrange the focusing optics behind the galvanometer scanner as seen in the beam direction. More broadly, irrespectively of the specific configuration of the optical system and the displacement mechanism as shown in the example of FIG. 2, a focusing optical system, in particular a lens or group of lenses or a focusing mirror with a focal length of less than 300 mm is preferred.

For locally removing the coating 5 to create an opening 9 which extends through coating 5, the device for guiding the laser beam moves the laser beam 7 over the surface, and the laser 7 is adjusted so that the ablation threshold of the material of coating 5 is exceeded and thus the coating is removed at the point of impingement. However, the output power of the laser is adjusted so that the ablation threshold of the substrate material, that is the material of the glass or glass ceramic of substrate 2, is not reached so that only the coating is removed. The glass ceramics marketed under the tradenames ROBAX and CERAN CLEARTRANS may be mentioned as an example here. For these glass ceramics the ablation threshold for a laser wavelength of 1064 nm is approximately 5.2*10¹⁷ W/m².

More broadly, without being limited to the specific exemplary embodiment discussed above, it is therefore advantageous if the materials of the glass or glass ceramic material and of the opaque coating are selected so that the ablation threshold of the material of the glass or glass ceramic substrate 2 is higher than the ablation threshold of the opaque coating 5, in particular in the infrared spectral range, more particularly at a wavelength of 1064 nm.

Furthermore, it is generally advantageous if the layer thickness of the opaque coating is not too large. This facilitates the removal by laser ablation on the one hand. On the other hand, this is advantageous for light transmission through the openings 9 in the area 10 of the coating. If the coating is too thick, the walls of the openings 9 will have a corresponding length and will swallow an unnecessary amount of light. Therefore, it is generally preferred for the opaque coating 5 to have a layer thickness of not more than 300 μm, more preferably not more than 160 μm, most preferably not more than 50 μm.

On the other hand, however, coatings that are too thin are also unfavorable, in particular in view of ensuring a sufficient degree of light blocking. Preference is given to layer thicknesses of more than 3 μm, preferably at least 5 μm. The minimum and maximum thicknesses given above are mean values of layer thickness.

The laser beam guiding device is controlled by a control device 13 which may for instance execute a program that translates the shape and location of the pattern feature into control signals by means of which the laser beam 7 is moved over the surface by the laser beam guiding device. Preferably, the control device also controls the laser 7, in particular with regard to switching on and off and laser intensity.

According to one exemplary embodiment, a pulsed laser 71 was selected which can be sufficiently well focused to ablate dots of the dimensions mentioned before. This was achieved with a neodymium-YAG laser with a wavelength of 1064 nm and a pulse length of 10 ps. A scanner with optics having a focal length of 255 mm was employed. The M2 factor is less than 1.4, preferably less than 1.2. The tubular beam had a diameter of 12 mm. Average output power W50 at 200 kHz was reduced to about 4 W. Other lasers may also be used. In particular a laser with a wavelength of 532 nm and a pulse length of more than 1 ns is advantageous, since the smaller wavelength allows for better focusing and due to the longer pulse length the material will not become stained which is disadvantageous in case of light colors. Furthermore, lasers in the ns range have a distinct cost advantage over lasers in the short ps range. In any case it is advantageous for the ablated features to have a width of less than 0.025 mm.

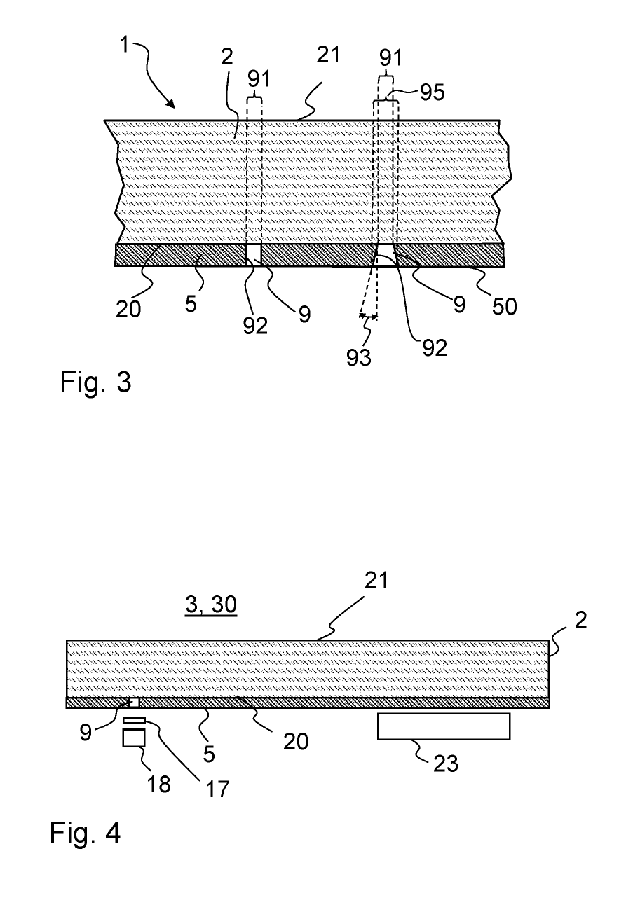

FIG. 3 is a schematic cross-sectional view of a glass or glass ceramic article 1 produced by the method according to the invention. An opening 9 has been introduced into the opaque coating 5. This opening has a width 91 of not more than 30 μm, preferably not more than 20 μm, at the bottom of the coating 5 or at the substrate surface exposed in the opening.

In the example shown on the left in FIG. 3, the wall 92 of opening 9 is substantially perpendicular. According to a further embodiment, opening 9 may taper from the surface 50 of the coating toward the glass or glass ceramic substrate 2. One exemplary embodiment of this case is illustrated by the opening 9 on the right in FIG. 3. Such an embodiment may be advantageous for introducing an opening even into rather thick coatings 5 by repeated or stepwise ablation. Preferably, however, the angle 93 between the wall 92 of opening 9 and the surface normal of the substrate is smaller than 20°, preferably smaller than 15°. This angle is the mean angle of the wall which can be easily determined trigonometrically from the ratio of the width 91 of the opening at the substrate to the width 95 at the surface of coating 5 and the thickness of coating 5. Accordingly, the following applies to the thickness D of the coating 5 and the difference B of widths 95, 91 of this embodiment: B/2D≦tan(20°), preferably B/2D≦tan(15°).

According to yet another embodiment, with the preferred layer thicknesses and the maximum width 91 of the opening at the substrate according to the invention, a condition is generally met according to which the width 91 of opening 9 is smaller than the layer thickness of the opaque coating 5.

As a result of both the smaller width of the opening compared to the layer thickness and the slight angle, if any, of the wall 92 relative to the vertical, the visual axis will not extend through the opening 9 but will end at the wall 92 already when viewing the opening 9 slightly obliquely. This in conjunction with the small width 91 of the opening results in the fact that the opening remains invisible to a viewer. It can only be perceived when light from a light source on the side of the glass or glass ceramic article 1 that is hidden to the viewer due to the light blocking layer 5 passes through the opening.

However, laser ablation may cause a dark discoloration of the coating. If the coating itself is dark, such discoloration and hence the opening 9 will remain invisible. However, this is different for coatings having a light color hue. In this case, the dark discoloration may be visible at the edges of the opening 9. This can be counteracted by adjusting the pulse frequency of the laser and the rate at which the laser beam is directed over the coating such that the points of incidence of the laser pulses do not overlap each other, which results in the desired dot pattern. According to this embodiment of the invention, it is thus even possible to produce openings that are invisible to a viewer in an opaque coating that has a color with an L value in the L*a*b color space of at least 20, preferably at least 40, more preferably at least 50. The L value of the color of the opaque coating may for example be determined using a spectrophotometer. The value relates to an exposed surface of the coating 5, that means it is not a color value measured across the glass or glass ceramic.

According to a refinement of the invention, a top-hat profile of the laser beam 7 is used in order to minimize the thermal impact in the peripheral area of the opening to be produced so as to avoid the staining effect. In this case, the edge regions of the initially Gaussian beam which have not enough energy for ablating the ink but yet have enough energy to heat the coating to an extent to cause discoloration thereof, are eliminated. Another advantage of a top-hat profile is better contour definition, since a Gaussian profile does not permit to remove multi-layered systems with sharp contours, although this effect causes blurring on a micrometer scale that is hardly visible or not visible at all to the eye.

The invention is most preferably implemented so that the coating is deposited on the surface 20 of the glass or glass ceramic substrate 2 that faces away from the user. Accordingly, the light from a light source will therefore first pass through the coating through opening 9, then through the glass or glass ceramic substrate and will then exit from the opposite face 21.

The invention can be employed in a variety of applications for backlit glass or glass ceramic articles of household appliances. The invention is particularly suitable for cooktops. A control panel, for example on a stove or oven, may also be implemented using a glass or glass ceramic article according to the invention. In case of a household appliance, the opaque coating serves to create a certain visual appearance on the one hand, on the other to hide the components of the household appliance.

Broadly, without being limited to the exemplary embodiments described below, the invention relates to a household appliance which has a control surface that is defined by the glass or glass ceramic article, and which comprises at least one light-emitting element arranged in the interior of the household appliance so that light emitted from the light-emitting element is incident onto the openings 9 of the area 10 in the opaque coating 5 and can pass through the openings 9 and the substrate 2.

FIG. 4 shows an example of a preferred embodiment of such a household appliance 3 in the form of a glass ceramic cooktop 30 comprising a cooktop panel that is formed by a glass ceramic article 1 according to the invention.

Regardless of the type of household appliance 3, the opaque coating 5 is preferably applied on the surface 20 of the glass or glass ceramic substrate 2 facing the interior. In the example of glass ceramic cooktop 30, the opaque coating 5 is accordingly provided on the lower surface of the substrate, which accordingly is a glass ceramic substrate 2 in this case. One or more heaters 23 are arranged below the glass ceramic substrate 2, for heating food to be cooked or cookware placed on the cooktop panel, or on face 21. The heaters 23 may comprise induction coils for an induction cooker, for example.

Without being limited to the illustrated exemplary embodiment, a light-emitting diode is used as the light-emitting element 18. Depending on the design of the opening, an array of a plurality of light-emitting diodes 18 may be used as well. The latter is favorable, for example, if the openings 9 are elongated and are to be illuminated the most uniformly possible. In order to allow much light to pass through the small opening, it is also possible according to yet another embodiment of the invention to use a laser diode as the light-emitting element.

Generally, without being limited to the illustrated example, it may moreover be favorable to arrange a diffusing element 17 in front of light-emitting element 18. Diffusing element 17 extends along a trench-shaped opening 9 and ensures that the light from light-emitting element 18 is distributed more evenly along trench-shaped opening 9. In this manner, a more uniform illumination of the linear display feature created with such a trench-shaped opening 9 is achieved.

The display feature created by the illuminated opening 9 may for instance serve to mark a cooking zone. Such marking is used to indicate which one of the cooking zones is currently enabled and heated. For this purpose, the trench-shaped opening 9 may for instance extend annularly around the area heated by heater 23.

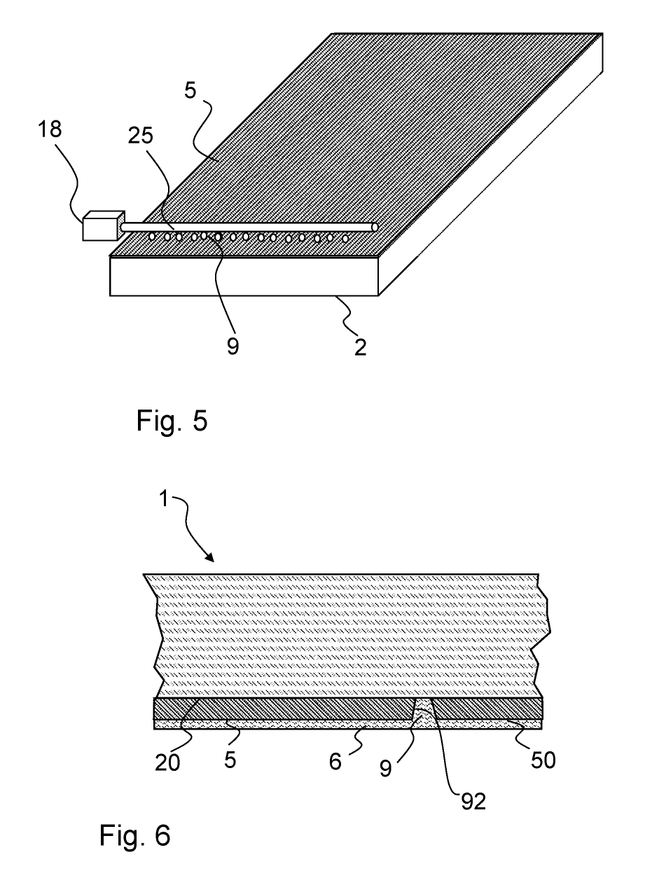

Besides a diffusing element 17, a side-emitting light guide is suitable as well for distributing the light emitted by light-emitting element 18 along openings 9. FIG. 5 shows an example. Here, openings 9 comprise a multitude of dot-shaped openings arranged in a straight line, so that when light passes through openings 9, the impression of a line-shaped display feature is created. A side-emitting light guide 25 extends along openings 9 and is optically coupled to light-emitting element 18 so that the light from light-emitting element 18 is injected into the light guide 25. Light guide 25 emits the injected light in distributed manner along its longitudinal extension and therefore also in distributed manner along the dot-shaped openings 9, so that openings 9 are uniformly illuminated. Besides a light-emitting diode as the light-emitting element, a laser diode is suitable for this embodiment as well. With such a laser diode, high light intensity can be injected even into a thin light guide. The latter can be arranged close to the openings so that the light can be efficiently directed to the openings. Regardless of the type of light source, the embodiment with a side-emitting fiber is also suitable for guiding light into regions that are strongly heated during operation of the household appliance, since in this case the light-emitting element itself need not be located in the heated region. In this way it is even possible to provide luminous display features within a cooking zone.

Generally, a coating on a glass or glass ceramic substrate may not only serve to prevent transparency. In addition, a coating may also be advantageous for sealing the coated side of the substrate. In the region of openings 9, such a sealing layer would however be interrupted. If a transparent sealing layer is used, it may as well be applied after introducing the openings 9, according to one embodiment of the invention, so that the openings will be covered or closed. The light from the light-emitting element will still be able to pass through openings 9 across the transparent sealing layer.

Such a refinement of the invention, in which opening 9 is sealed by a transparent sealing layer 6 is shown in FIG. 6. The sealing layer may cover the opening 9 and/or even fill the opening, as illustrated. Suitable for sealing layer 6 are for instance transparent silicone layers, silicone-based layers and transparent sol-gel layers. Furthermore, such a sealing layer may even be used to fix a diffusing element 17 or a side-emitting light guide or even the light-emitting element close to the opening.

A sealing layer as represented by layer 6 refers to a coating which protects the glass or glass ceramic material and/or the opaque coating 5 from environmental influences. Such environmental influences may for instance include condensation products. Therefore, the sealing layer should be impermeable to liquid- and oil-containing substances as included in food, for example. Should such substances penetrate into coating 5, this might cause visible, unattractive alterations in visual appearance.

Moreover, the opaque coating 5 itself may constitute a sealing layer for protecting the surface of the glass or glass ceramic covered by coating 5.

Besides lighting that is not visible in the off state, another application is to create an invisible mark which serves as an anti-counterfeit feature. If it is desired to identify whether a particular glass or glass ceramic article is a genuine product, this can then be easily verified by examining the article under back lighting. Therefore, according to one aspect of the invention, it is contemplated to use a mark in the form of a preferably linear opening 9 in the opaque coating 5 created according to the invention for labeling an origin of the glass or glass ceramic article.

As stated above, the ratio of ablated to the total treated surface area is a process parameter of the method according to the invention. If the ratio is too great this may cause a visual alteration of the processed areas. Therefore, a transition area may be created exhibiting a reduced ratio compared to that of the core area of the treated surface area. However, this measure will often be unsatisfactory for areas with very light and very dark decorative layers, since in these cases it will not always be possible to obtain a sufficient dead front effect.

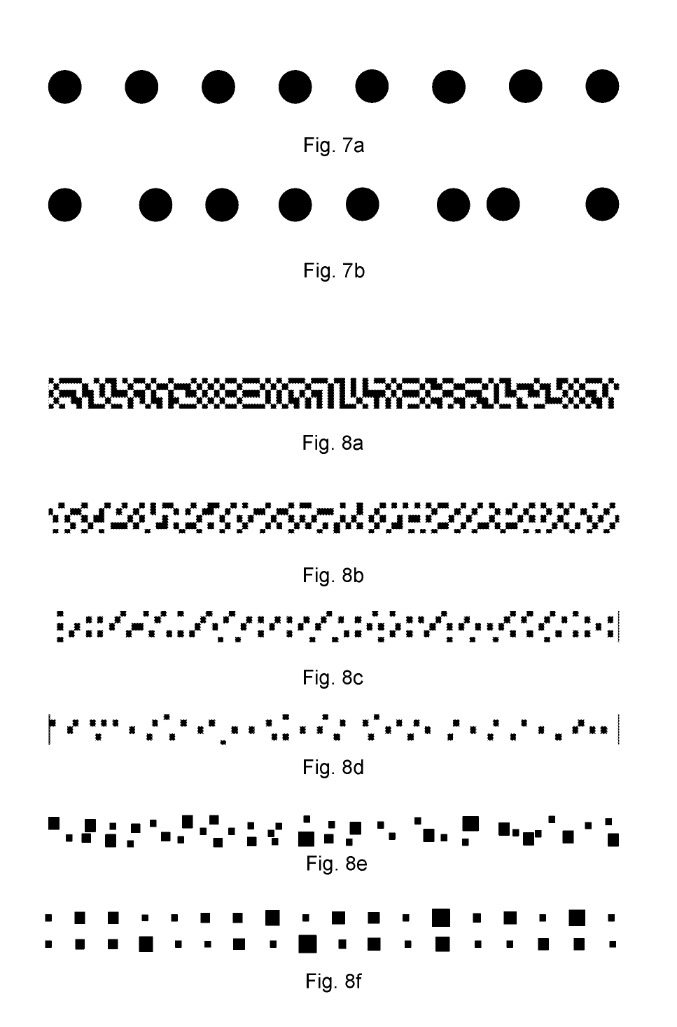

According to a further embodiment of the invention, the dead front effect can be improved by dithering, that is a random distribution of the size and position of the openings 9, which is also referred to as a stochastic or irregular distribution. In this case, the spacing and the size of the openings 9 is not kept constant throughout the entire processed area, but is varied by subdividing a cutout into a multitude of smaller areas. FIG. 7a shows a row of a regular pattern, while FIG. 7b shows a row of an irregular pattern. Here, the spacings between the individual openings 9 or dots vary randomly.

FIGS. 8a to 8d illustrate the appearance of an area treated by dithering according to the invention for different ratios of ablated surface area to the total treated surface area. In FIG. 8a this ratio is 50%, in FIG. 8b 25%, in FIG. 8c 12.5%, and in FIG. 8d 6.25%. The spacings between the individual openings 9 or dots vary statistically, in particular in a randomly distributed manner.

FIG. 8e shows the appearance of an area treated by dithering according to the invention, where both the spacings and the size of the openings 9 or dots 9 vary statistically, in particular in a randomly distributed manner

FIG. 8f shows the appearance of an area treated by dithering according to the invention, where only the size of the openings 9 or dots 9 varies statistically, in particular in a randomly distributed manner.

A dot size of 20 μm can be very advantageous when dithering is used, since in this case even agglomerations, that is openings coincidentally located close to each other, will not be visually perceived as a difference in brightness.

Dithering permits to achieve overall improved display performance of the treated glass or glass ceramic substrate.

If some finer patterns are superimposed, for example in displays with regularly arranged picture elements (pixels), this may cause a visual impression of an overlapped coarser pattern. This moire effect can be reduced or often even avoided by the use of dithering.

For generating irregular patterns by dithering, pulsed lasers with ultrashort pulses with a pulse duration of a few picoseconds are preferably used as lasers which can be used for the method of the invention. The wavelengths of such pulsed lasers are either in the IR range or in the UV range.

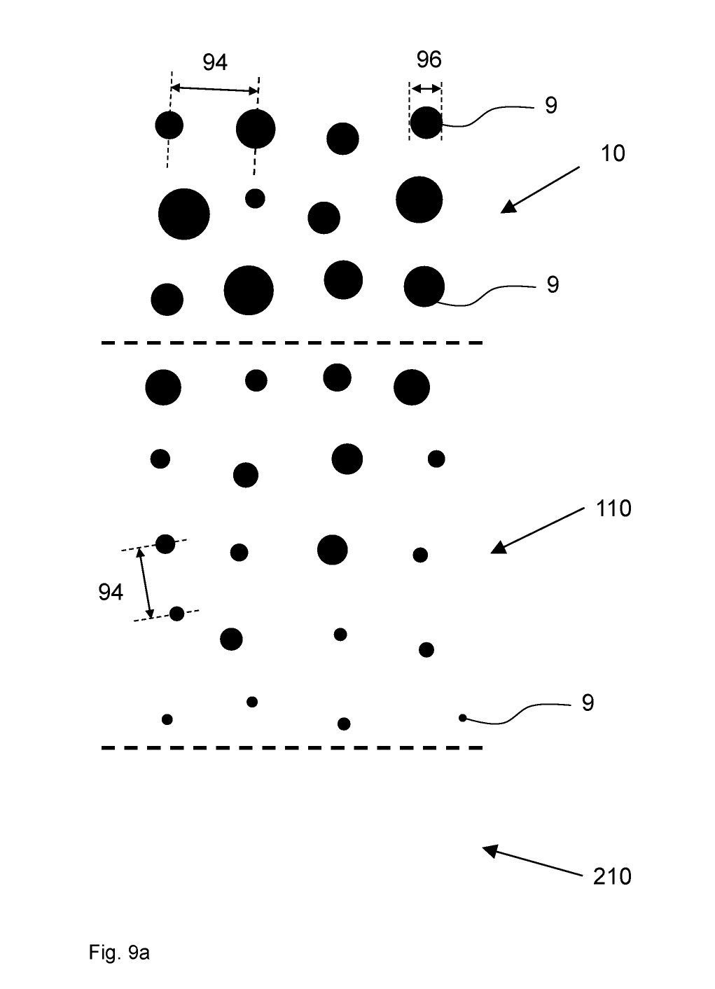

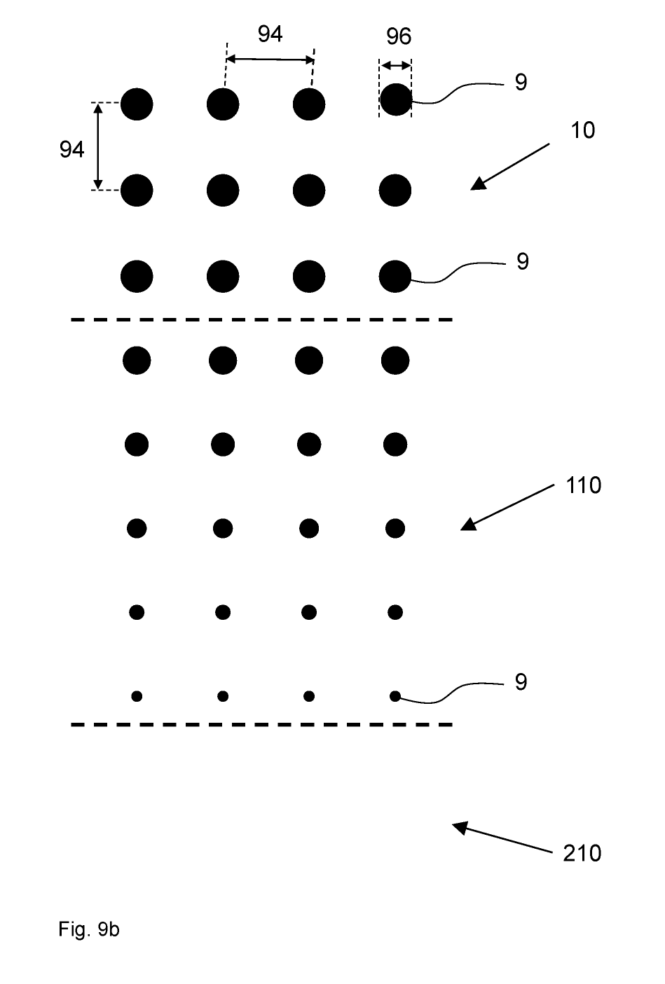

FIG. 9a shows a portion of a pattern of dot-shaped openings 9, not drawn to scale. The illustrated pattern comprises a perforated core area 10 and a perforated transition area 110. In transition area 110, the average ablated surface area is smaller than in the core area 10. Moreover, transition area 110 exhibits a gradient so that the ablated percentage surface area reduces from the core area 10 toward the non-perforated area 210. The openings 9 have a size 96 and a spacing 94 to each other.

FIG. 9b finally shows a portion of another pattern of dot-shaped openings 9, not drawn to scale. The illustrated pattern comprises a perforated core area 10 and a perforated transition area 110. In the perforated core area 10, the dot-shaped openings 9 form a regular pattern with consistent sizes 96 and spacings 94 of the openings 9. In transition area 110, the average ablated surface area is smaller than in the core area 10. Moreover, transition area 110 exhibits a gradient so that the ablated percentage surface area decreases from the core area 10 toward the non-perforated area 210.

In transition area 110, the openings 9 also form a regular pattern.

### LIST OF REFERENCE NUMERALS

1 Glass or glass ceramic article
2 Sheet-like glass or glass ceramic substrate
3 Household appliance
5 Opaque coating
7 Pulsed laser beam
9 Openings or holes in 5
10 Perforated core area
11 Apparatus for laser ablation
13 Control device
15 Galvanometer scanner
16 X-Y table
17 diffusing element
18 Light-emitting element
10 focusing optics
20, 21 Faces of 2
23 Heater
25 Side-emitting light guide
30 Glass ceramic cooktop
50 Surface of 5
71 Laser
91 Width of 9 on substrate 2
92 Wall of 9
93 Angle of wall 92 relative to the surface normal of the substrate
94 Spacing
95 Width of opening 9 at surface 50 of 5
96 Size of opening
110 Perforated transition area
210 Non-perforated area

What is claimed is:

1. A method for producing a glass or glass ceramic article, comprising the steps of:
providing a sheet-like glass or glass ceramic substrate having two opposite faces, the substrate exhibiting light transmittance in the visible spectral range from 380 nm to 780 nm of at least 1% for visible light that passes across the substrate from one face to the opposite face;
providing an opaque coating on one face of the substrate, the opaque coating exhibiting light transmittance of not more than 5% in the visible spectral range;
directing a pulsed laser beam onto the opaque coating to locally remove the opaque coating by ablation down to the face of the substrate, repeatedly at different locations, thereby producing a pattern of a multitude of openings defining a perforated core area in the opaque coating so that the opaque coating becomes semi-transparent in the perforated core area; and
directing a pulsed laser beam onto the opaque coating to locally remove the opaque coating by ablation down to the face of the substrate, repeatedly at different locations, thereby producing another pattern of a multitude of openings defining a transition area along a periphery of the perforated core area in the opaque coating, the transition area having an ablated percentage surface area that is lower on average within the transition area than within the core area, the ablated percentage surface area being defined by a ratio of ablated surface area to non-processed surface area.

2. The method as claimed in claim 1, wherein the openings are arranged at different spacings to each other and/or have different sizes.

3. The method as claimed in claim 2, wherein the spacings and/or the size of the openings vary stochastically according to a random distribution.

4. The method as claimed in claim 1, wherein the openings have a shape of circular dots.

5. The method as claimed in claim 1, wherein the openings are spaced from each other by less than 200 μm.

6. The method as claimed in claim 1, wherein the openings have a size of less than 30 μm.

7. The method as claimed in claim 1, wherein the ablated percentage surface area of the core area is greater than 0.5%.

8. The method as claimed in claim 1, wherein the ablated percentage surface area is reduced by less than 2% per mm in the transition area.

9. The method as claimed in claim 1, further comprising cleaning the substrate after directing a pulsed laser beam onto the opaque coating.

10. The method as claimed in claim 9, wherein the cleaning comprises using an adhesive roller to clean the substrate.

11. The method as claimed in claim 9, further comprising, after the cleaning step, providing the core and/or transition area with a transparent coating or a transparent sealing layer.

12. The method as claimed in claim 1, wherein the substrate comprises a material that has an ablation threshold that is higher than an ablation threshold of the opaque coating for a wavelength of more than 532 nm.

13. The method as claimed in claim 1, wherein the opaque coating comprises a matrix of an oxidic network with decorative pigments embedded therein.

14. The method as claimed in claim 1, wherein the opaque coating comprises a color with an L value in the L*a*b color space of at least 20.

15. A glass or glass ceramic article, comprising:
a glass or glass ceramic substrate having two opposite faces;
an opaque coating on one of the two opposite faces, wherein the opaque coating exhibiting a light transmittance of not more than 5% in the visible spectral range from 380 nm to 780 nm,
wherein the opaque coating comprises an area that is provided with a pattern of openings defining a perforated core area, which openings allow light that is incident onto the opaque coating to pass through the opaque coating and the substrate so that the perforated core area appears semi-transparent, the openings being spaced by less than 200 μm; and
wherein the opaque coating comprises a transition area along a periphery of the perforated core area, which includes further ablated openings in a manner so that the ablated percentage surface area defined by a ratio of ablated surface area to non-processed surface area is lower on average within the transition area than within the core area.

16. The glass or glass ceramic article as claimed in claim 15, further comprising at least one light-emitting element that is arranged so that light emitted from the light-emitting element is incident onto the substrate at the openings and is able to pass through the opaque coating and the substrate.

17. The glass or glass ceramic article as claimed in claim 15, wherein the openings are arranged at different spacings to each other and/or have different sizes.

18. The glass or glass ceramic article as claimed in claim 15, wherein the light-emitting element comprises at least one light-emitting diode or laser diode.

19. The glass or glass ceramic article as claimed in claim 18, further comprising a diffusing element for distributing the light emitted by the light-emitting element throughout the openings.

20. The glass or glass ceramic article as claimed in claim 18, further comprising a side-emitting light guide for distributing the light emitted by the light-emitting element throughout the openings.
